(19) United States
(12) Patent Application Publication
(10) Pub. No.: US 2004/0093272 A1
(43) Pub. Date: May 13, 2004

(54) Method for the ordering and consignment of goods

(76) Inventors: Walter Rosenbaum, Paris (FR); Karlheinz Reich, Radolfzell (DE)

Correspondence Address: SIEMENS SCHWEIZ, I-44, INTELLECTUAL PROPERTY, ALBISRIEDERSTRASSE 245, ZURICH, CH-8047, CH

(21) Appl. No.: 10/237,064

(22) Filed: Sep. 9, 2002

Related U.S. Application Data
(63) Continuation of application No. PCT/DE01/01035, filed on Mar. 16, 2001.

(30) Foreign Application Priority Data
Mar. 20, 2000 (DE) 100 13 497.1

(51) Int. Cl. G06F 17/60

(52) U.S. Cl. 705/26

(57) ABSTRACT

The present invention comprises a method for processing on-line orders wherein the on-seller is liberated from having to maintain cumbersome or uneconomical warehouse stocks. Herein, after an order is received from a customer, the on-line seller subcontracts with a supplier for the good(s) sought by the customer and sends out a printing order. Both subcontract and printing order include an identification key which is later used to associate printed materials and good(s), so as to facilitate special packing of the good(s) with special materials associated with the on-line seller, and the forwarding of the finally packaged good(s) to the customer. The associating of good(s) and packing material, packing, and forwarding good(s) to customer is performed at the supplier.

### CROSS REFERENCE TO RELATED APPLICATIONS

The present application is a continuation of International Application number PCT/DE01/01035, filed Mar. 16, 2001, and German Application number 100 13 497,1 filed Mar. 20, 2000, both of which are incorporated herein by reference.

### BACKGROUND OF THE INVENTION

The present invention relates to the on-line ordering and consigning of good(s) and more particularly to method for relieving an on-line seller or entity with the burdens of warehousing. Such burdens can have a crushing economic effect on on-line seller or other entity as well as store front enterprises to which the present invention also applies, The invention will be primarily discussed as applied to an on-line seller,

As is known in the art, an on-line seller requires a rather large warehouse store with a broad range of good(s) from which ordered good(s) are obtained, invoiced with customer information such as address data, and then sent off to the customer. The printed data, packaging material, and labels are set out in the respective layout of the corresponding online-provider. The large store not only requires physical space, but may also entail special care requirements including refrigeration, pest control and other such maintenance. Likewise, some good(s) may require special individualized assemble, have a limited shelf like, and/or entail other costly upfront investments wherein a limited time exists for recoupment of such investments from potential customers. As is typical, customers flock to good(s) providers with the highest, freshest, fastest and most convenient good(s). Hence a significant business pressure is placed on the on-line merchant to at least have prompt access to the good(s).

To reduce the large warehouse stock, electronic orders based on incoming buying orders are directed by the on-line seller to a manufacturer or supplier of the ordered good(s). Then the manufacturer or supplier produces the ordered good(s) according to specified requirements or withdraws them from his or her warehouse. The good(s) so provided come with a limited delivery profile. After being made available, the good(s) are neutrally packaged and sent back to the on-line seller. Neutral packaging is necessitated by the manufacture or supplier servicing the on-line seller or entity. A desired shipment by the online seller, which includes not only the good(s) but invoices, cover letter, client information, packaging material, and labels of the online-provider in his layout, cannot be realized by the manufacturer or supplier. Accordingly, the use of a third party, subcontracting manufacturing or supplier includes its limitations, including: no personalized customer attention; lack of personalized on-line seller attention; missed advertising and informationals opportunity by the on-line seller; and the like. Therefore, a need exists for a method wherein third party subcontractors can be relied upon by on-line sellers to reduce warehousing burdens, while still effecting the above missed personalized touches and opportunities.

### SUMMARY OF THE INVENTION

It is an advantage of the present invention to facilitate personalized touches and effect advertising and informationals opportunities for on-line sellers making use of one or several third party subcontractors. It is a further advantage to effect cost savings and efficiency in online business transactions and sale of good(s) in particular. It is another advantage to encourage on-line businesses by promoting third party subcontracting use as well as introducing other business opportunities for existing on-line entities. These and other advantages will become clear from the present invention.

The present invention comprises a method wherein a bifurcation of packing materials and good(s) to be sold is made at the on-line seller. Upon receipt of a purchase order from a customer, a first order for good(s) may be placed with a third party subcontracting manufacturer or supplier of the good(s) (hereinafter supplier). A second order for printing of individualized packing material, invoices, cover letter, informationals and advertisements is placed with a printing or print center. The good(s) and printing orders may be placed electronically and are accompanied by an identification key. The printed material is sent to the supplier, who matches the good(s) and materials according to the key. The good(s) are appropriately packaged at the supplier and sent off to the customer. The key may be a bar code, facilitating automation, and/or in human readable form, facilitating manual handling. The printing may be performed at the on-line seller, provider, supplier, or stand alone entity. Location of printing center includes built in costs savings per obviating certain procedural steps including the forwarding of a printing order, forwarding of printed material, and handling of same.

The present invention further comprises a method for processing an on-line purchase order for a good(s), said order received by an on-line seller from a customer, comprising the steps of: at said on-line seller, placing a print order for a printed product with a print center, said print order and printed product comprising at least seller data, good(s) data, customer data, packing instruction, and identification key; at said on-line seller, placing a supply order for said good(s) with a supplier, said supply order including at least said identification key; at said print center conveying said printed product to said supplier; at said supplier, associating said printed product and good(s) in accordance with said identification key, packaging said good(s) in accordance with said printed product and forwarding packaged good(s) to said customer.

In addition, the present invention further comprises a method for processing an order from a customer for a good(s) comprising the steps of: requesting printing materials and assigning an identification key to said materials, requesting said good(s) and assigning said identification key to said good(s), associating said materials and said good(s) in accordance with said identification key, and packaging said good(s) with said materials and forwarding said good(s) to said customer with said materials

### BRIEF DESCRIPTION OF THE SEVERAL VIEWS OF THE DRAWINGS

The novel features and method steps believed characteristic of the invention are set out in the claims below. The invention itself, however, as well as other features and advantages thereof, are best understood by reference to the detailed description, which follows, when read in conjunction with the accompanying drawing, wherein:

FIG. 1 depicts a schematic of a procedure with an autonomous printing center.

### DETAILED DESCRIPRION OF THE INVENTION

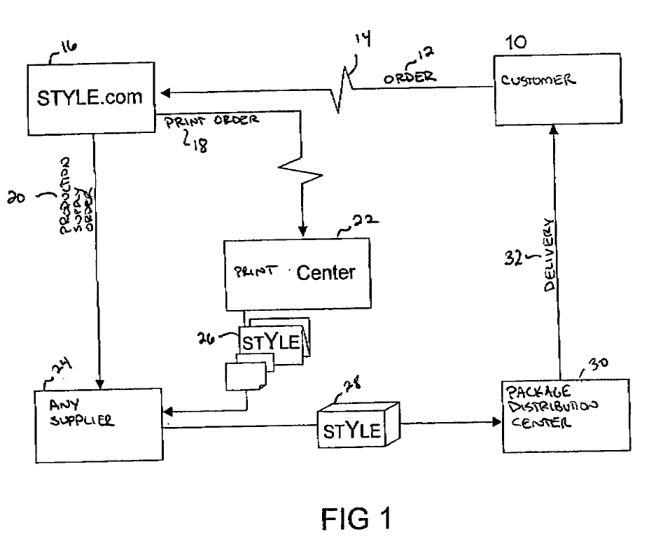

As depicted in FIG. 1, customer 10 places a purchase order 12, via his or her on-line access (not shown) and electronically sends 14 the order to an on-line seller 16. The on-line seller is depicted as having the name STYLE.com. The on-line seller 16 records the order and stores it with an allocated identification key.

The on-line seller then effects two orders, a printing order 18 for printing material and supply order 20 good(s). The orders are depicted in electronic form but may take any form acceptable in business practices. The printing order 18 is directed to a print center 22. The supply order 20 is directed to supplier 24. The sequence of the orders may be such that the one of the goods and printing material is available first or relatively simultaneously. Should one be available without the other, the one is stored until the other is available. Both print and supply orders include an identification key as well as any desired special instructions. The identification key may comprise a bar code and/or other human and/or machine readable indicia. In addition, both orders may include on-line seller data, customer data, goods data, and packaging data with special instructions data. The on-line seller data may include: seller name and address, invoice, seller cover letter to customer, seller information such as advertisements, informationals, and the like, company logo(s), company color(s), and the like. The customer data may include: customer name and address, customer special requests, and the like. The goods data may include: good(s) identification, good(s) special assembly, goods special handling, other instructions and the like. The packaging data may include: special wrapping specific to on-line seller, customer, goods, situation (e.g. holiday); special handling specific to the handling of the goods, delivery, on-line seller, customer etc; special assemble of the good(s), package, etc.; special routing for the package, etc. In addition, the packaging data may include special instructions to any additional information associated with the handling and processing of the packaged good(s) as well as associating the printing order and good(s) as discussed below.

The print center may comprise at least one printer networked with communication and processing means. The at least one printer may be a color laser printer, color ink jet or laser printer, and the like. The print center may include operators and other means, along with the above of which is known in the art. The printed material may include special papers, labels, packaging and the like as may be required by a print order.

Returning to the figure, printer material 26 is directed, in one or several appropriately addressed envelope(s) or package(s), to the supplier of the goods 24 which are the subject of the printed material. The envelope(s) or package(s) include the identification key also sent in the supply order. The envelope may therefore be assigned by the bar code reader as well as by the supplier personnel.

The printed material 26 is then assigned to the appropriate good(s) via the identification keys at the supplier 24. The good(s) and printing material are prepared for shipment, for example, the printing material is attached, if requested the final packing is done in the respective online-seller packing paper, and the provider labels are applied with the receiver addresses. Finally, package(s) 28 emerges which is sent accordingly 32 via regular packing center 30 to the customer 10 who initially placed the purchase order. Delivery is facilitated by information provided in the print and/or supply orders, the information being assembled with the good(s) and most likely affixed to the package via labeled addresses.

In an alternative embodiment, the supplier 24 may have his or her own printing center (not shown). Herein, the print and supply orders would be inclusive and the steps (and associated costs) of routing a print order to a print center, generating printing material and forwarding such material to the supplier is obviated. Herein lies a business opportunity for the supplier to expand his or her services into printing specialized material for their customers packages. To this end, it may further be an option for the supplier to maintain printing stocks unique to regular customers (i.e. special papers stocks). Per the above method, the on-line seller is freed from warehousing and actually may expand his or her offerings to include any suppliers and therefore practically any good(s). It is understood in the above description that the present invention may be applied to one or several good(s), the two being used interchangeably above. The above method may also be applied to any on-line entity capable of business to business or business to customer services. For example, Style.com having received the supply order, may forward such order to XYZ.com who would then undertake the above method steps to have the order filled. In still another embodiment, the print center may be located at the on-line seller or other on-line business entity. In yet another embodiment, the above method may be effected by businesses not being exclusively or entirely on-line. Herein, communication is effected by telephone, post and the like.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

We claim:

1. A method for processing an on-line purchase order for a good, said order received by an on-line seller from a customer, comprising the steps of:
at said on-line seller, placing a print order for a printed product with a print center, said print order and printed product comprising at least seller data, good data, customer data, packing instruction, and identification key;
at said on-line seller, placing a supply order for said good with a supplier, said supply order including at least said identification key;
at said print center conveying said printed product to said supplier;
at said supplier, associating said printed product and good in accordance with said identification key, packaging said good in accordance with said printed product and forwarding packaged good to said customer.

2. The method according to claim 1, wherein said identification key is a bar code.

3. The method according to claim 1, wherein said identification key is human readable indicia.

4. The method according to claim 1, wherein said print order further comprises a cover letter from said on-line seller to said customer and informationals regarding said seller.

5. The method according to claim 1, wherein said seller data includes at least one of: seller name and address; invoice; seller cover letter to customer; seller information such as advertisements; company logo; and company color.

6. The method according to claim 1, wherein said customer data includes at least one of: customer name and address; and customer special requests.

7. The method according to claim 1, wherein said good data includes at least one of: good identification; good special assembly; and good special handling.

8. The method according to claim 1, wherein said packaging requirements includes at least one of: special wrapping specific to on-line seller, customer, good, or situation; special handling specific to the handling of the good, delivery, on-line seller, or customer; special assemble of the good, or package; and special routing for the package.

9. A method for processing an order from a customer for a good comprising the steps of:
requesting printing materials and assigning an identification key to said materials,
requesting said good and assigning said identification key to said good,
associating said materials and said good in accordance with said identification key, and
packaging said good in accordance with said materials and forwarding said good to said customer with said materials.

10. The method according to claim 9, wherein said printing materials includes seller data, good data, customer data, and packing instructions.

11. The method according to claim 9, wherein said step of requesting said good includes seller data, good data, customer data, and packing instructions which are implemented with said step of packaging.

12. The method according to claim 9, wherein said identification key is a bar code.

13. The method according to claim 9, wherein said identification key is human readable indicia.

14. The method according to claim 9, wherein said step of requesting printing is made from an on-line seller to a print center.

15. The method according to claim 14, wherein said identification key is provided to said print center during said step of requesting printing.

16. The method according to claim 15, wherein said print center is a part of said on-line seller.

17. The method according to claim 15, wherein said print center is a part of a supplier of said good.

18. The method according to claim 9, wherein said step of requesting said good is made to a good supplier.

19. The method according to claim 18, wherein said identification key is provided to said good supplier with said step of requesting said good; and wherein said steps of associating and packaging are performed at said good supplier.

20. The method according to claim 9, wherein said order is received on-line and said steps of requesting printing materials and requesting said good are performed on-line.
